(19) United States
(12) Patent Application Publication
(10) Pub. No.: US 2017/0179723 A1
(43) Pub. Date: Jun. 22, 2017

(54) CLUSTERED ENERGY-STORING MICRO-GRID SYSTEM

(71) Applicant: NATIONAL CHUNG SHAN INSTITUTE OF SCIENCE AND TECHNOLOGY, Taoyuan City (TW)

(72) Inventors: CHIEN-HAO CHEN, TAOYUAN CITY (TW); KUO-KUANG JEN, TAOYUAN CITY (TW); YU-JEN LIU, MINXIONG TOWNSHIP (TW); GARY W. CHANG, MINXIONG TOWNSHIP (TW); SHANG-YI CHEN, MINXIONG TOWNSHIP (TW)

(21) Appl. No.: 14/970,816

(22) Filed: Dec. 16, 2015

(51) Int. Cl. H02J 3/38

(52) U.S. Cl. CPC H02J 3/382

(57) ABSTRACT

A clustered energy-storing micro-grid system includes a renewable energy device, a clustered energy-storing device, an electrical power conversion device and a local controller. Before coordinating and allocating power to a plurality of loads, the clustered energy-storing device stores and releases the power in a centralized manner. This, coupled with the control exercised by the local controller over the electrical power conversion device, controls the micro-grid system in its entirety so that the micro-grid system operates in cost-efficient optimal conditions, under a predetermined system operation strategy, and in a system operation mode.

### FIELD OF TECHNOLOGY

The present invention relates to micro-grid systems and more particularly to a clustered energy-storing micro-grid system.

### BACKGROUND

A micro-grid evolves from a grid framework and usually involves various renewable energy sources, electrical power conversion devices, communication facilities, control devices, energy-storing components and client loads. Compared with traditional large-scale grids, micro-grids are close to power-consuming loads and therefore dispense with long-distance power transmission/distribution lines; hence, micro-grids reduce line loss, dispense with investments required for power transmission/distribution lines and cut operation expenses. Furthermore, micro-grids operate in multiple power management modes with respect to power generation, power transmission and power distribution; hence, micro-grids exhibit high energy utilization efficiency, high system reliability and high grid security performance while operating effectively, flexibly and independently.

Renewable energy-derived power in a micro-grid system is intermittently unstable and dispersive; hence, it is necessary to strike a balance between the demand and supply of system power by carrying out power regulation with an energy-storing device in the system. The energy-storing device takes the power left over from renewable energy-derived power supplied to a load and allocates, when an energy-storing power level accumulates to a certain extent, the energy-storing power level to system auxiliary power use, for example, supplying emergency standby power, assisting the system in adjusting the frequency or voltage, reducing the use of conventional fossil fuel-derived power, and saving power clients' electricity costs. Every conventional micro-grid system equipped with an energy-storing device has a “single-point” framework and therefore is available to a single specific power client only. When connected to multiple power clients, a conventional micro-grid system equipped with an energy-storing device is restrained by the capacity of the energy-storing device and therefore needs a multi-client control strategy, and in consequence the conventional micro-grid system fails to satisfy multiple power clients.

### SUMMARY

It is an objective of the present invention to provide a “clustered” energy-storing micro-grid system to thereby integrate clustered energy-storing devices in the micro-grid system and supply power in a clustered multiple-point manner to local power clients.

Another objective of the present invention is to provide an operation control strategy suitable for a clustered energy-storing micro-grid system so that, by predicting the power level required for a power-consuming load, the micro-grid system operates in cost-efficient optimal conditions, for example, in a situation conducive to prevention of a waste of power which might otherwise occur if the energy-storing device power level reaches its rated level and therefore causes the micro-grid system to generate excessive power.

In order to achieve the above and other objectives, the present invention provides a clustered energy-storing micro-grid system, having micro-grids coupled to an AC utility power end to form a clustered network and supply power to loads formed from power consumption levels of clients, respectively, the micro-grid each comprising: a renewable energy device for generating power from a renewable energy source; a clustered energy-storing device coupled to the renewable energy device to store power left over from power consumed by the load and supplied by the renewable energy device; an electrical power conversion device coupled to the AC utility power end, the renewable energy device and the clustered energy-storing device so that a power form of power received from the renewable energy device and power received from the clustered energy-storing device is converted into a power form required for the load; and a local controller coupled to the electrical power conversion device to determine a system operation mode of the local controller by detecting a current level of power required for the load, a current level of power generated from the renewable energy device, and a level of power stored in the clustered energy-storing device, and control a power form of the power supplied by the electrical power conversion device to the load in accordance with the determined system operation mode.

In the micro-grid system, the electrical power conversion device comprises: a DC/DC converter coupled to the renewable energy device to convert DC power generated from the renewable energy device into DC power which is stable and capable of maximum power generation; a bidirectional DC converter coupled to the clustered energy-storing device and the DC/DC converter to thereby, when the clustered energy-storing device is supplying power, convert an output of the clustered energy-storing device into an output DC power or convert input power into an input DC power to be input to the clustered energy-storing device; and a DC/AC converter coupled to the local controller, the load, the AC utility power end, the DC/DC converter and the bidirectional DC converter to convert DC power into AC power and vice versa, wherein the output DC power provided by the clustered energy-storing device and converted is converted into AC power required for the load, or AC power provided by the AC utility power end is converted into power to be input to the bidirectional DC converter.

In the micro-grid system, the local controller controls the bidirectional DC converter to output the output DC power from the clustered energy-storing device or input the input DC power to the clustered energy-storing device, according to the configured system operation mode.

In the micro-grid system, the local controller controls AC power which the DC/AC converter outputs to the load in accordance with the configured system operation mode.

In the micro-grid system, a plurality of system operation modes configured for the local controller includes a load following mode in which, when the power generated from the renewable energy device exceeds the power required for the load, the local controller controls the electrical power conversion device so that the renewable energy device solely supplies a power consumption level of each client of the load and stores in the clustered energy-storing device a residual portion of power supplied by the renewable energy device; and when the power generated from the renewable energy device is less than the power required for the load, the local controller controls the electrical power conversion device so that the clustered energy-storing device provides standby power to thereby charge the renewable energy device with residual power left over from power consumed by the load.

In the micro-grid system, a plurality of system operation modes configured for the local controller includes a fixed power mode in which the local controller controls the electrical power conversion device so that the renewable energy device solely supplies the load with a fixed power level and stores in the clustered energy-storing device power left over from power consumed by the load and supplied by the renewable energy device when power generated from the renewable energy device exceeds power required for the load, and the local controller controls the electrical power conversion device so that the clustered energy-storing device serves as a source of standby power, and the power supplied by the clustered energy-storing device compensates for inadequacy of power supplied by the renewable energy device to the load when power generated from the renewable energy device is less than power required for the load.

In the micro-grid system, the clustered energy-storing device has a predetermined stored power level so that, in the load following mode, when the power stored in the clustered energy-storing device has not reached the predetermined stored power level, the clustered energy-storing device does not provide standby power, and the AC utility power end serves as a source of standby power, thereby allow AC utility power to compensate for inadequacy of power supplied by the renewable energy device to the load.

In the micro-grid system, the system operation modes further include an emergency power mode, wherein the local controller is configured to operate in the emergency power mode when the AC utility power end stops supplying power, wherein, in the emergency power mode, the local controller controls a direction of current and a strength of current in the electrical power conversion device to allow the power stored in the clustered energy-storing device to be output to function as emergency power or allow the clustered energy-storing device to store power.

In the micro-grid system, the local controller controls the electrical power conversion device so that the clustered energy-storing device can only be charged at a specific time.

Therefore, the present invention provides a clustered energy-storing micro-grid system which has a clustered energy-storing device to store and release power in a centralized manner, coordinate and allocate power to a plurality of loads timely. This, coupled with the control exercised by the local controller over the electrical power conversion device, controls the micro-grid system in its entirety so that the micro-grid system operates in cost-efficient optimal conditions, under a predetermined system operation strategy, and in a system operation mode.

### BRIEF DESCRIPTION

Objectives, features, and advantages of the present invention are hereunder illustrated with specific embodiments in conjunction with the accompanying drawings, in which:

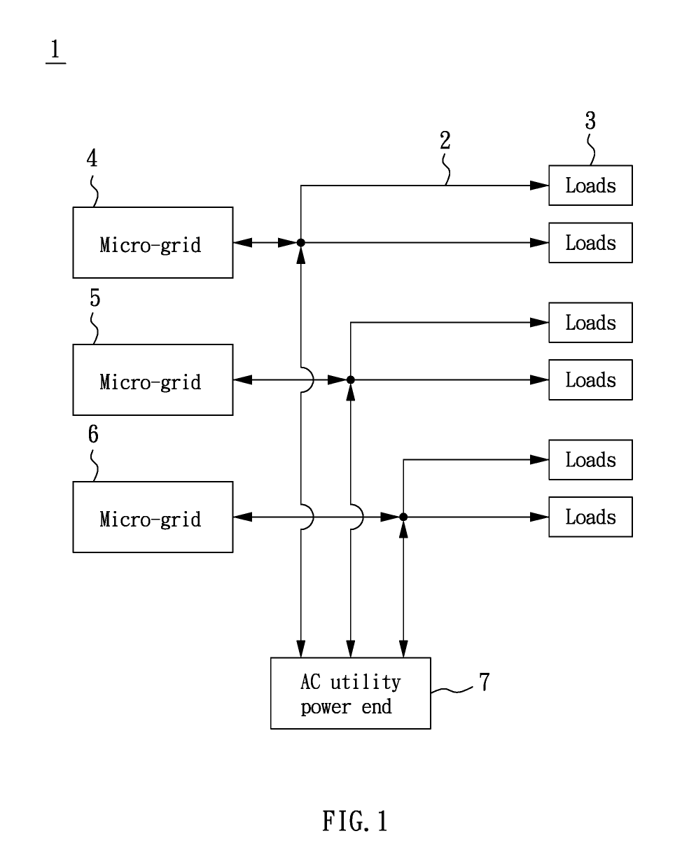

FIG. 1 is a schematic view of the framework of a clustered energy-storing micro-grid system according to an embodiment of the present invention;

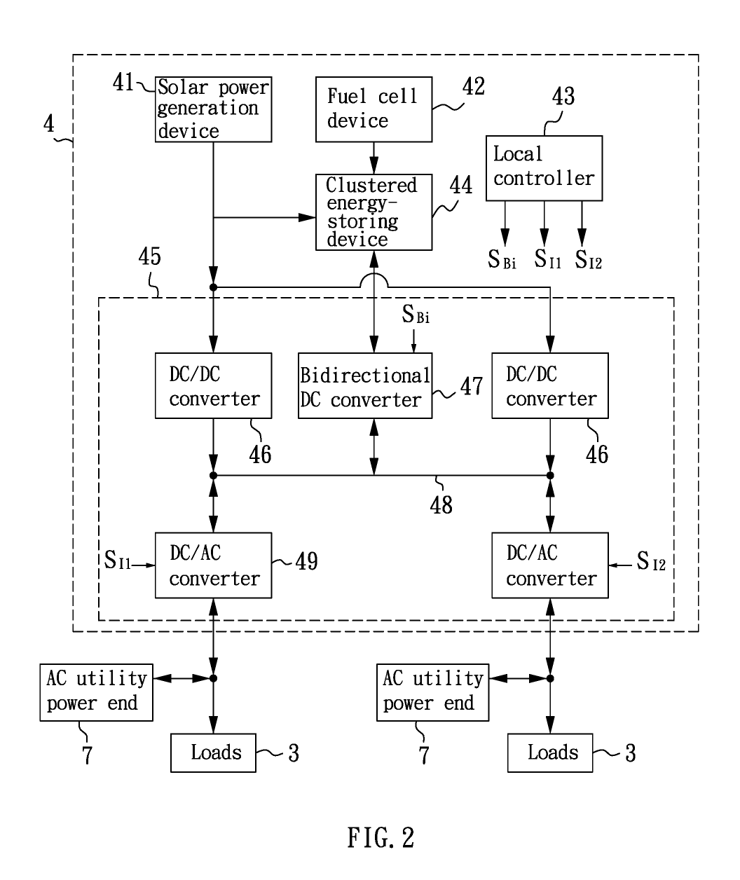

FIG. 2 is a schematic view of a clustered energy-storing micro-grid according to an embodiment of the present invention;

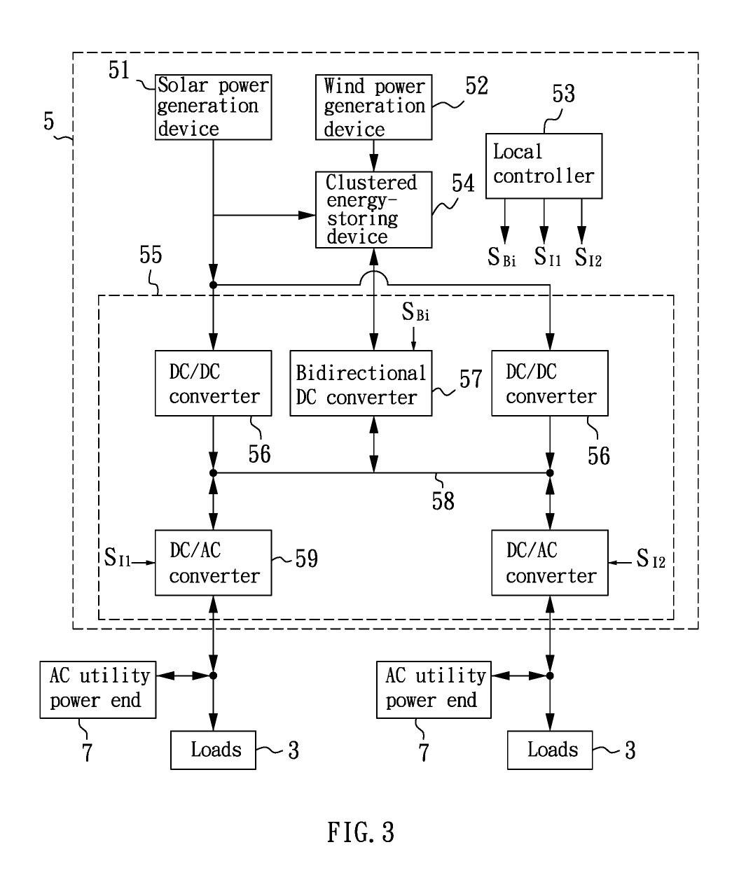

FIG. 3 is a schematic view of another clustered energy-storing micro-grid according to an embodiment of the present invention;

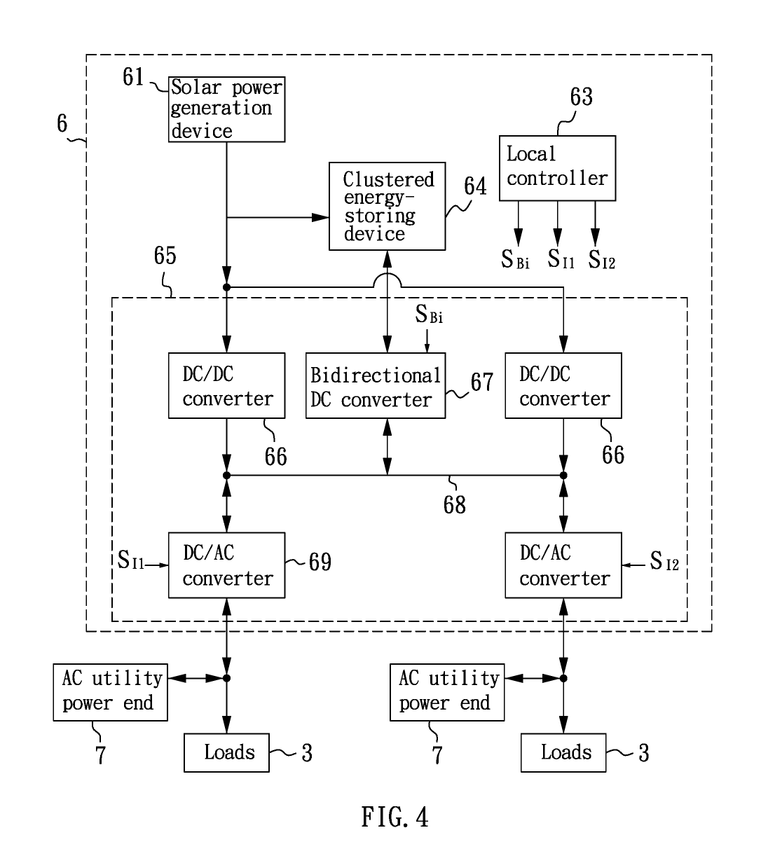

FIG. 4 is a schematic view of yet another clustered energy-storing micro-grid according to an embodiment of the present invention; and

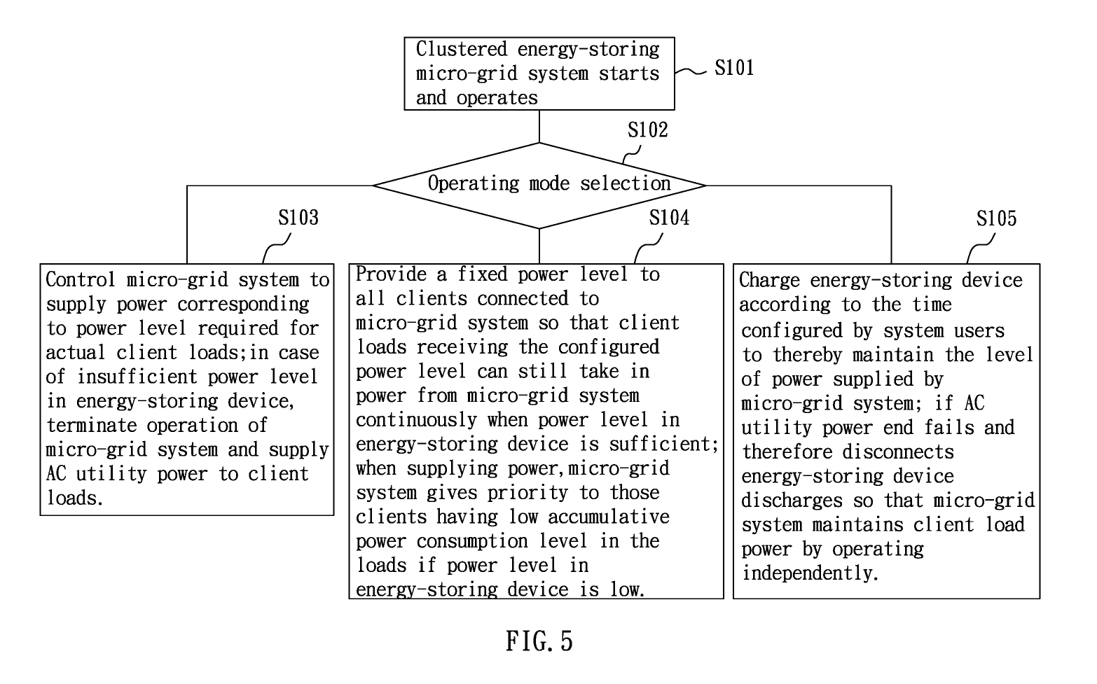

FIG. 5 is a schematic view of the process flow of operation of a system operation mode of the clustered energy-storing micro-grid system according to an embodiment of the present invention.

### DETAILED DESCRIPTION

Referring to FIG. 1, there is shown a schematic view of the framework of a clustered energy-storing micro-grid system 1 according to an embodiment of the present invention.

The clustered energy-storing micro-grid system 1 comprises a plurality of micro-grids 4, 5, 6. The micro-grids 4, 5, 6 are each connected to a load. In this embodiment, the micro-grids 4, 5, 6 are each connected to two loads 3 for exemplary purposes. Referring to FIG. 1, for example, each load matches a client to thereby allow each micro-grid matches a plurality of clients, and the loads 3 which must be dealt with by each micro-grid are collectively known as a load of the micro-grid. The micro-grids 4, 5, 6 are connected to the loads 3 by an AC wire 2 for coupling purposes. The micro-grids 4, 5, 6 and the loads 3 are coupled to an AC utility power end 7 through the AC wire 2. Therefore, the micro-grids 4, 5, 6 together form a clustered micro-grid.

In this embodiment, the micro-grids 4, 5, 6 and the loads 3 are in the number of three and six, respectively, for exemplary purposes, but the present invention is not limited thereto.

In the aspect illustrated with FIG. 1, the clustered energy-storing micro-grid system 1 of the present invention has a stack framework and comprises at least one of the micro-grids 4, 5, 6 according to the quantity of power clients (that is, the loads 3). Users may expand the micro-grids 4, 5, 6 so as to increase the micro-grids 4, 5, 6 as needed.

In the aspect illustrated with FIG. 1, the micro-grids 4, 5, 6 in the micro-grid system 1 of the present invention are each provided with only one energy-storing device (that is, a clustered energy-storing device described later). Therefore, unlike the conventional single-point framework which has a specific energy-storing unit capable of supplying power to only one specific power client (that is, load), an energy-storing device in each micro-grid 4, 5, 6 of the present invention controllably allocates power to two or more loads 3 according to the power level required for the loads 3 and a system operation mode in operation, thereby circumventing the conventional limitation of the scope of power supply to a single client.

In the aspect illustrated with FIG. 1, the micro-grid system 1 of the present invention is coupled to the AC utility power end 7 so that the loads 3 can selectively use the micro-grids 4, 5, 6 or AC utility power as the sole power supply source, or the power supplied by the micro-grids 4, 5, 6 and an AC utility power end 140 is mixed so that the mixed power is supplied to the loads 3.

Referring to FIG. 2 through FIG. 4, there are shown schematic views of the clustered energy-storing micro-grids 4, 5, 6, respectively, according to an embodiment of the present invention. Parts and components of the micro-grids 4, 5, 6 are described below.

The clustered energy-storing micro-grid 4 comprises a solar power generation device 41, a fuel cell device 42, a local controller 43, a clustered energy-storing device 44 and an electrical power conversion device 45. The electrical power conversion device 45 comprises a DC/DC converter 46, a bidirectional DC converter 47, a DC power bus 48 and a DC/AC converter 49. The AC output end of the DC/AC converter 49 is coupled to the AC utility power ends 7 and the loads 3.

The clustered energy-storing micro-grid 5 comprises a solar power generation device 51, a wind power generation device 52, a local controller 53, a clustered energy-storing device 54 and an electrical power conversion device 55. The electrical power conversion device 55 comprises a DC/DC converter 56, a bidirectional DC converter 57, a DC power bus 58 and a DC/AC converter 59. The AC output end of the DC/AC converter 59 is coupled to the AC utility power ends 7 and the loads 3.

The clustered energy-storing micro-grid 6 comprises a solar power generation device 61, a local controller 63, a clustered energy-storing device 64 and an electrical power conversion device 65. The electrical power conversion device 65 comprises a DC/DC converter 66, a bidirectional DC converter 67, a DC power bus 68 and a DC/AC converter 69. The AC output end of the DC/AC converter 69 is coupled to the AC utility power ends 7 and the loads 3.

FIG. 2, FIG. 3 and FIG. 4 show renewable energy devices and regard the solar power generation devices 41, 51, 61 as the first renewable energy device. FIG. 2, FIG. 3 and FIG. 4 differ from each other in terms of the second renewable energy device. Referring to FIG. 2, the fuel cell device 42 serves as the second renewable energy device. Referring to FIG. 3, the wind power generation device 52 serves as the second renewable energy device. Referring to FIG. 4, no second renewable energy device is provided. The clustered energy-storing micro-grids of the present invention are hereunder described and illustrated with FIG. 2. Persons skilled in the art understand that the description of FIG. 2 is applicable to related parts of FIG. 3 and FIG. 4.

The quantity of the renewable energy devices shown in diagrams illustrative of the embodiments of the present invention serves illustrative purposes; hence, the quantity of the renewable energy devices is not limited to one or two. The types of renewable energy sources are not restricted to sunlight, wind and fuel. Whatever device which generates power from a renewable energy source can function as a renewable energy device of the present invention to thereby provide the power consumption level required for a load. Referring to FIG. 2, renewable energy devices, such as the solar power generation device 41 and the fuel cell device 42, are coupled to the clustered energy-storing device 44 and the electrical power conversion device 45, respectively. Alternatively, renewable energy devices, such as the solar power generation device 41 and the fuel cell device 42, are coupled to the clustered energy-storing device 44, and then the clustered energy-storing device 44 is coupled to the electrical power conversion device 45.

The clustered energy-storing device 44 is coupled to the solar power generation device 41 to store the residual power left over from the power consumed by the loads 3 and supplied by the solar power generation device 41. The clustered energy-storing device 44 comprises batteries of different types, such as a lead-acid battery, a lithium ferrous battery and a sodium-sulfur battery. The clustered energy-storing device 44 consists of a combination of energy-storing components of different types or different specifications.

The electrical power conversion device 45 is coupled to the solar power generation device 41 and the clustered energy-storing device 44 to convert the DC power generated from the renewable energy device, such as the solar power generation device 41, and the DC power stored in the clustered energy-storing device 44 into power of a power form required for a load so that the required power is supplied to the load. For example, when the loads 3 require AC power, the electrical power conversion device 45 converts the DC power into AC power.

The local controller 43 is coupled to the electrical power conversion device 45 and adapted to provide multiple system operation modes (which are described later) so that one of the system operation modes is determined at the user's request or in accordance with specific system operation information, such as the current power level required for the loads 3, current level of power generated from the solar power generation device 41, and level of power stored in the clustered energy-storing device 44. The local controller 43 communicates with, for example, an electric meter for detecting the current power level required for the loads 3, a maximum power tracking circuit for detecting the current level of power generated from the solar power generation device 41, and a battery management system for detecting the level of power stored in the clustered energy-storing device 44 separately, so as to gather system operation information.

The local controller 43 controls the electrical power conversion device 45. The electrical power conversion device 45 determines the level of power supplied by the solar power generation device 41 to the loads 3, the level of power stored in the clustered energy-storing device 44, and the level of power which is supplied by the clustered energy-storing device 44 to the loads 3 and must be consumed. Therefore, the local controller 43 substantially controls the operation of the micro-grid 4 in its entirety.

The DC/DC converter 46 is coupled to the solar power generation device 41 to convert the DC power generated from the solar power generation device 41 into DC power which is stable and capable of maximum power generation. The DC/AC converter 49 is coupled to the local controller 43, the loads 3, the AC utility power ends 7, the DC/DC converter 46 and the bidirectional DC converter 47 to convert DC power into AC power, wherein the output DC power provided by the clustered energy-storing device 44 and converted is converted into AC power required for the loads 3, and AC power provided by the AC utility power ends 7 is converted into power to be input to the bidirectional DC converter 47.

The bidirectional DC converter 47 is coupled to the clustered energy-storing device 44 and the DC/DC converter 46 to thereby, when the clustered energy-storing device 44 is supplying power, convert the output of the clustered energy-storing device 44 into an output DC power (that is, releasing power) or convert input power into an input DC power to be input to the clustered energy-storing device 44 (that is, storing power).

The DC power of the DC/DC converter 46 and the bidirectional DC converter 47 is collected by the DC power bus 48. Then, the DC/AC converter 49 converts the collected DC power into AC power for use by the loads 3.

The local controller 43 is coupled to the bidirectional DC converter 47 and the DC/AC converter 49 by connection lines (not shown). By being coupled to the connection lines, the local controller 43 transmits control signal S_{Bi} in accordance with a system operation mode to control the bidirectional DC converter 47 to output the output DC power from the clustered energy-storing device 44 (that is, releasing power) or input the input DC power into the clustered energy-storing device 44 (that is, storing power) and transmit control signals S₁₁, S₁₂ to thereby control the level of AC power which the DC/AC converter 49 outputs to each load 3. Therefore, given the transmission of instructions, such as control signals S_{Bi}, S₁₁, S₁₂, the local controller 43 not only controls the direction of current and the strength of current in the electrical power conversion device 45 but also controls the direction of current and the strength of current between devices (such as an AC grid, each load 3, the solar power generation device 41, and the clustered energy-storing device 44) coupled to the electrical power conversion device 45, so as to substantially control the operation of the micro-grid 4 in its entirety.

The system operation modes include a load following mode, a fixed power mode and an emergency power mode as described below.

In the load following mode, the micro-grid system 1 provides the required power level to the loads 3 one by one. Referring to FIG. 2, in the situation where not only has the required power level of the loads 3 exceeded the level of power generated from the solar power generation device 41 but the clustered energy-storing device 44 has also reached a predetermined stored power level, the local controller 43 controls the electrical power conversion device 45 to thereby transmit the power generated from the solar power generation device 41 to the DC/DC converter 46, and then the DC/AC converter 49 converts the DC power into AC power so that the AC power is supplied to meet a portion of the power consumption requirement of the loads 3; meanwhile, in case of insufficient renewable energy-derived power, the clustered energy-storing device 44 will release power, and then the bidirectional DC converter 47 transmits DC power to the DC/AC converter 49 for conversion into AC power to supplement the aforesaid insufficient other portion of the power consumption requirement while the solar power generation device 41 is supplying power to the loads 3. In the situation where the level of power required for the loads 3 exceeds the level of power generated from the solar power generation device 41 and the clustered energy-storing device 44 has not reached the predetermined stored power level, the other portion of power required for the loads 3 is supplied by the AC utility power ends 7, wherein the AC power is directly transmitted to each load 3 by the AC wire 2.

If the level of power required for the loads 3 is lower than the level of power generated from the solar power generation device 41, the solar power generation device 41 will solely supply all the loads 3 with their respective required levels of power, regardless of the level of the power stored in the clustered energy-storing device 44; if residual power is available, it will flow to the clustered energy-storing device 44 for storage (that is, charging), or the AC utility power ends 7 will perform a power resale process (by feeding the residual power to the AC grid to thereby achieve the purpose of reselling power to an electric utility of the AC grid).

In the fixed power mode, the micro-grid system 1 provides a fixed level of power to all the loads 3. Referring to FIG. 2, in the situation where the clustered energy-storing device 44 has reached a predetermined stored power level and the level of power generated from the solar power generation device 41 is insufficient, the bidirectional DC converter 47 transmits DC power to the DC/AC converter 49 for conversion into AC power to meet the other portion of power requirement of the loads 3, thereby compensating for the inadequacy of power supplied by the solar power generation device 41. When the clustered energy-storing device 44 has not reached the predetermined stored power level, the local controller 43 controls the electrical power conversion device 45 to give priority to clients having low accumulative power consumption level in the loads 3. When the power generated from the solar power generation device 41 is less than the power required for the loads 3, the local controller 43 controls the electrical power conversion device 45 so that the clustered energy-storing device 44 serves as a source of standby power, thereby allowing the clustered energy-storing device 44 to provide power which compensates for the inadequacy of power supplied by the solar power generation device 41 to the loads 3.

Regarding the emergency power mode, the local controller 43 switches quickly to this mode as soon as a utility grid malfunctions (for example, as a result of a breakdown), so as to control the micro-grid system 1 to operate independently and maintain the level of power supplied to the loads 3. For example, the DC/AC converter 49 is capable of performing island detection to detect whether the AC grid is malfunctioning. When the DC/AC converter 49 detects that the AC grid is malfunctioning, it is feasible to disconnect the AC grid from an AC utility power end 1 so that the micro-grid system 1 operates independently and therefore maintains the level of power required for the loads 3; meanwhile, the local controller 43 controls the clustered energy-storing device 44 to release power for use as emergency power. For example, when the power generated from a renewable energy device (such as the solar power generation device 41) is insufficient for use by the loads 3, the local controller 43 uses control signal S_{Bi} to control the bidirectional DC converter 47 to transmit supplementary power to the DC/AC converter 49 to serve as emergency power and be converted into AC power for use by the loads 3. For example, before the micro-grid system 1 begins to operate in the emergency power mode or after the micro-grid system 1 has operated in the emergency power mode, the clustered energy-storing device 44 can be charged according to the time configured by a system user. For example, in the situation where a renewable energy device (such as the solar power generation device 41) has supplied power required for the loads 3 and residual power is available, the local controller 43 uses control signal S_{Bi} to control the bidirectional DC converter 47 to store the residual power in the clustered energy-storing device 44 so that the power thus stored serves as emergency power subsequently.

In an embodiment, the load following mode is denoted by mode 1, the fixed power mode by mode 2, and the emergency power mode by mode 3 to thereby match the system operation modes; after considerations have been given to the stored power level status and weather status (in the daytime and the nighttime) of the clustered energy-storing device 44, the sources of electrical power which the loads 3 receive from the micro-grid 4 under different system operation modes in this embodiment are shown in Table 1 below.

TABLE 1
relation between energy-storing status and power source of load

| stored power level | | source of electrical power which a load receives from | | |
|---|---|---|---|---|
| status of clustered | | the micro-grid under different system operation modes | | |
| energy-storing device | | mode 1 | mode 2 | mode 3 |
| daytime | sufficient | renewable | renewable | renewable energy + |
| | stored | energy + | energy + | energy-storing |
| | power level | energy-storing | energy-storing | |
| | insufficient | renewable | renewable | power generation |
| | stored | energy + | energy + | is unavailable or |
| | power level | AC utility | AC utility | trace power is |
| | | power | power | provided by |
| | | | | renewable energy |
| | | | | only |
| nighttime | sufficient | energy-storing + | energy-storing + | energy-storing |
| | stored | AC utility | AC utility | |
| | power level | power | power | |
| | insufficient | AC utility | AC utility | power generation |
| | stored | power | power | is unavailable or |
| | power level | | | trace power is |
| | | | | provided by |
| | | | | renewable energy |
| | | | | only |

FIG. 5 is a schematic view of the process flow of operation of a system operation mode of the clustered energy-storing micro-grid system 1 according to an embodiment of the present invention.

When the clustered energy-storing micro-grid system 1 starts and begins to operate (S101), one of the system operation modes (operating modes) is selected (S102) so that the clustered energy-storing micro-grid system 1 operates in the selected system operation mode. The system operation modes include a load following mode (S103), a fixed power mode (S104) and an emergency power mode (S105).

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A clustered energy-storing micro-grid system, having micro-grids coupled to an AC utility power end to form a clustered network and supply power to loads formed from power consumption levels of clients, respectively, the micro-grid each comprising:
a renewable energy device for generating power from a renewable energy source;
a clustered energy-storing device coupled to the renewable energy device to store power left over from power consumed by the load and supplied by the renewable energy device;
an electrical power conversion device coupled to the AC utility power end, the renewable energy device and the clustered energy-storing device so that a power form of power received from the renewable energy device and power received from the clustered energy-storing device is converted into a power form required for the load; and
a local controller coupled to the electrical power conversion device to determine a system operation mode of the local controller by detecting a current level of power required for the load, a current level of power generated from the renewable energy device, and a level of power stored in the clustered energy-storing device, and control a power form of the power supplied by the electrical power conversion device to the load in accordance with the determined system operation mode.

2. The micro-grid system of claim 1, wherein the electrical power conversion device comprises:
a DC/DC converter coupled to the renewable energy device to convert DC power generated from the renewable energy device into DC power which is stable and capable of maximum power generation;
a bidirectional DC converter coupled to the clustered energy-storing device and the DC/DC converter to thereby, when the clustered energy-storing device is supplying power, convert an output of the clustered energy-storing device into an output DC power or convert input power into an input DC power to be input to the clustered energy-storing device; and
a DC/AC converter coupled to the local controller, the load, the AC utility power end, the DC/DC converter and the bidirectional DC converter to convert DC power into AC power and vice versa, wherein the output DC power provided by the clustered energy-storing device and converted is converted into AC power required for the load, or AC power provided by the AC utility power end is converted into power to be input to the bidirectional DC converter.

3. The micro-grid system of claim 2, wherein the local controller controls the bidirectional DC converter to output the output DC power from the clustered energy-storing device or input the input DC power to the clustered energy-storing device, according to the configured system operation mode.

4. The micro-grid system of claim 2, wherein the local controller controls AC power which the DC/AC converter outputs to the load in accordance with the configured system operation mode.

5. The micro-grid system of claim 1, wherein a plurality of system operation modes configured for the local controller includes a load following mode in which,
when the power generated from the renewable energy device exceeds the power required for the load, the local controller controls the electrical power conversion device so that the renewable energy device solely supplies a power consumption level of each client of the load and stores in the clustered energy-storing device a residual portion of power supplied by the renewable energy device; and
when the power generated from the renewable energy device is less than the power required for the load, the local controller controls the electrical power conversion device so that the clustered energy-storing device provides standby power to thereby charge the renewable energy device with residual power left over from power consumed by the load.

6. The micro-grid system of claim 5, wherein the clustered energy-storing device has a predetermined stored power level so that, in the load following mode, when the power stored in the clustered energy-storing device has not reached the predetermined stored power level, the clustered energy-storing device does not provide standby power, and the AC utility power end serves as a source of standby power, thereby allow AC utility power to compensate for inadequacy of power supplied by the renewable energy device to the load.

7. The micro-grid system of claim 6, wherein the system operation modes further comprises an emergency power mode, wherein the local controller is configured to operate in the emergency power mode when the AC utility power end stops supplying power, wherein, in the emergency power mode, the local controller controls a direction of current and a strength of current in the electrical power conversion device to allow the power stored in the clustered energy-storing device to be output to function as emergency power or allow the clustered energy-storing device to store power.

8. The micro-grid system of claim 1, wherein a plurality of system operation modes configured for the local controller includes a fixed power mode in which the local controller controls the electrical power conversion device so that the renewable energy device solely supplies the load with a fixed power level and stores in the clustered energy-storing device power left over from power consumed by the load and supplied by the renewable energy device when power generated from the renewable energy device exceeds power required for the load, and the local controller controls the electrical power conversion device so that the clustered energy-storing device serves as a source of standby power, and the power supplied by the clustered energy-storing device compensates for inadequacy of power supplied by the renewable energy device to the load when power generated from the renewable energy device is less than power required for the load.

9. The micro-grid system of claim 8, wherein the clustered energy-storing device has a predetermined stored power level so that, in the fixed power mode, the local controller controls the electrical power conversion device to give priority to clients having low accumulative power consumption level in the loads if power stored in the clustered energy-storing device does not reach the predetermined stored power level.

10. The micro-grid system of claim 1, wherein the local controller controls the electrical power conversion device so that the clustered energy-storing device can only be charged at a specific time.
